(19) United States
(12) Patent Application Publication
(10) Pub. No.: US 2017/0153165 A1
(43) Pub. Date: Jun. 1, 2017

(54) SYRINGE ASSEMBLY FOR WITHDRAWING TWO SEPARATE PORTIONS OF FLUID FOLLOWING A SINGLE ENGAGEMENT WITH FLUID PORT

(71) Applicant: Chidozie O. Nwadigo, Point of Rocks, MD (US)

(72) Inventor: Chidozie O. Nwadigo, Point of Rocks, MD (US)

(21) Appl. No.: 15/280,279

(22) Filed: Sep. 29, 2016

Related U.S. Application Data
(60) Provisional application No. 62/222,784, filed on Nov. 30, 2015.

(51) Int. Cl. G01N 1/14; B01L 3/02

(52) U.S. Cl. CPC G01N 1/14; B01L 3/0217; B01L 2400/0478; B01L 2300/0832

(57) ABSTRACT

In one or more embodiments, there is a dual syringe for the collection of fluid samples which enables taking two distinct samples, and a method of use thereof. Preferably the dual syringe is for single use. Generally, the dual syringe has three components: an outer barrel; an inner barrel that fits inside the outer barrel, locks to the outer barrel and has a rubber fitting on its tip so it can function as a plunger for the outer barrel; and a plunger for the inner barrel. There is a one-way valve in a nozzle opening or passage of the inner syringe enabling inward flow only. In a method of use, an initial portion of sample fluid, e.g., from a sampling port of a bioreactor vessel, is drawn into the inner barrel of the device by pulling on the plunger. The one-way valve prevents backflow of that initial portion of sample fluid thereby protecting the ideally aseptic chamber of the outer barrel. A subsequent sample can then be collected in the outer barrel without the two samples by overcoming or otherwise unlocking the inner barrel from the outer barrel, and pulling on the inner barrel. The sample in the outer barrel is distinct from the sample in the inner barrel. Each barrel can establish direct communication with the device tip, allowing the user to draw two distinct samples that do not interact with each other.

### CROSS REFERENCE TO RELATED APPLICATION(S)

This application claims priority from U.S. Provisional Patent Application Ser. No. 62/222,784, filed Nov. 30, 2015, and which is incorporated by reference herein.

### BACKGROUND OF THE INVENTION

Field of the Invention

The present invention relates to sampling devices that reduce contamination and a method of use thereof, and more particularly, to a dual syringe sampling device that can take two distinct samples with only a single connection to a sampling port or the like.

Description of the Related Art

To develop, manufacture, and continuously supply vaccines and therapeutic proteins, and for other reasons, scientists employ cell culturing in bioreactor vessels. Every bioreactor vessel must have a way for the scientist to extract as many samples of cell culture fluid as necessary, using a process known as “sampling.” Sampling devices such as syringes or collection tubes generally are unable to separate the initial portion of the fluid sampled from the rest of the sample. Separation of the initially collected fluid and the rest of the sample is important to avoid contaminating a desired sample with fluid which first emerges from the port, because fluid resident in the sampling path will not be representative of the fluid in the culture vessel. Since the fluid port (sampling port) is not aseptic, disinfectants may be applied to it to prevent inadvertent introduction of contaminants into the culture vessel. When a disinfectant is used, the fluid sample may be tinged with disinfectant and thus may not be representative of the rest of the fluid in the vessel. For this reason, operators often do not apply disinfectant to the sampling port immediately prior to obtaining a sample for analyses or other processing, thereby avoiding the risk of disinfectant contaminating the culture vessel.

To collect separate initial and subsequent portions of fluid samples, traditional sampling devices require the user to take a sample with a first sampling device (first syringe) in order to “flush” the sampling path and port of residue and possible contaminants, and then repeat the entire sampling procedure with a second sampling device (second syringe). This is not ideal in situations where each engagement of the sampling port poses inherent risks, such as contamination of the culture fluid, which could easily translate to a loss of hundreds to millions of dollars in resources, time, scientist morale, schedule upsets, and investigations. In addition, repeated engagement of the fluid port is inconvenient to the operator and slows up the sampling process.

Satisfactory solutions to this problem have continued to evade development. For example, while there are syringes and devices that are capable of injecting two distinct samples at a time, a suitable device to withdraw two distinct samples has not been developed.

U.S. Pat. No. 4,313,440 to Ashley shows a double chambered syringe. It has two chambers and two plungers. The primary function is for sequential injection of a dye material followed by a flushing liquid, such as in nuclear medicine.

U.S. Pat. No. 9,068,157 to Bruecher shows a device for sampling cultures. The device uses two separate syringes (a first, sterile syringe (not shown in Bruecher) and a second syringe). In addition, there is a Luer-Lok® taper for the first syringe. The device also has two check valves and an automatic valve which opens when it receives the first, sterile syringe. The procedure is to attach the first syringe, which opens the valve, then pull back on the plunger to withdraw a sample through a tube, and past a first check valve which is part of the sampling port structure. The first check valve prevents reverse flow of the sample liquid. The second check valve prevents flow of fluid in an upward direction. The first syringe is removed. Once the sample is withdrawn, the plunger of the second syringe is pulled back to withdraw air from the stub, then pressed downward to force air through the second check valve down towards the tube to push remaining culture back into the culture vessel (not shown). This structure and process is intended to avoid air pockets.

WIPO Patent Publication No. 2013/021186 to Haughey shows a double chambered syringe which is intended to deliver two injections in quick succession without the liquids mixing prior to injection. Since the device does prevent the liquids from mixing, it has a temporary seal in the tip of the first plunger to prevent flow in the injection direction until the plunger is pressed. In operation, there is a first composition in a first chamber in a first or outer barrel. There is a second composition in a second chamber in second or inner barrel. There is an annular seal member preventing mixing of the first and second compositions. Pressing the plunger first causes the first composition to pass through nozzle. After injection of the first composition, the annular seal has been deformed (by the inward projection in the wall of the barrel proximate the injection end) and therefore unseals the orifice of the second chamber, enabling the contents of the second chamber to flow through the orifice and nozzle when the plunger is depressed beyond a certain position.

WIPO Patent Publication No. 2014/001880 to Nandeesh discloses a dual chambered syringe for providing a homogenous mixture of two substances. Its purpose is for injecting and mixing substances. It is not for withdrawal of an initial portion of a culture followed by a specimen portion.

WO84/00011 to Des sapt discloses a syringe with two compartments. The syringe is intended for injection purposes, so the seal between the two compartments breaks or opens for mixing of liquids from each compartment. The Des sapt device is not for withdrawal of an initial portion of a fluid followed by a specimen portion.

Bioreactors are controlled environments which scientists use to grow cells for production of biologics, such as therapeutic proteins. Bioreactors contain access points, known as sampling ports, from which samples can be taken and evaluated. It is these ports which the device is intended to interact with in the preferred embodiment of the invention. In the past, two syringes have been used to remove fluid from the bioreactor at the sampling port. First, one syringe is used to remove an initial portion of the sample. Then, a second syringe is used to remove the desired sample to test.

What is needed is one device that is simple and may be used for removal of a first or initial portion of liquid followed by collection of a sample excluding the initial portion. Its use will seek to maintain the integrity of both the culture fluid and the sample during sample collection.

### SUMMARY OF THE INVENTION

In accordance with one or more embodiments, the present invention is a dual syringe for the collection of fluid samples which allows for the taking of two distinct samples at the same time (with only a single connection to a sampling port), and a method of use of such device. The dual syringe generally includes two barrels, one inside of the other (an inner barrel and an outer barrel which is radially outside of the inner barrel). The barrels are sequentially filled, in part by taking advantage of a pressure differential between the chamber of each barrel and the chamber or channel which is the source of the fluid sample.

Each barrel or chamber has its own respective plunger. The inner barrel may have a standard syringe plunger that has a rubber seal at its forward end or tip. The inner barrel has a rubber fitting at its forward end so that in effect it functions as a plunger for the outer barrel.

In a preferred embodiment, the plunger of the outer barrel (e.g., the inner barrel) has a locking mechanism to lock the inner barrel to the outer barrel while the plunger of the inner barrel or chamber is in use. The locking mechanism may be two hook members on a flange end of the inner barrel, which hook members grip a flange of the outer barrel. In use, the locking mechanism can readily be overcome, but is sufficient to prevent the inner barrel from being moved inadvertently while the inner barrel's plunger is being withdrawn.

In another embodiment, locking the inner barrel to the outer barrel can be accomplished by friction or wedges between a peripheral surface of the inner barrel or rubber fitting of the inner barrel with the interior of the outer barrel.

The locking mechanism prevents inadvertent separation of the seal by the rubber fitting of the inner barrel with respect to a fluid passage into the inner barrel because both the inner barrel and the outer barrel can make direct contact with a nozzle tip of the dual syringe. Accordingly, there is selective communication of the inner and outer barrels with the sampling port, allowing a sample to be drawn into either barrel without making contact with the other barrel. Therefore, the user can draw two distinct samples into one device at the same time, without having to first empty the device and without risking contamination of a culture vessel by the exposure of the sampling port (which can become contaminated during the time it takes to change sampling devices in traditional sampling methods).

Another aspect of the device is a one-way valve located in an entry passage of the inner barrel. This one-way valve prevents an initial portion of the sample that is drawn into the inner barrel from flowing back towards the device tip. This valve remains closed even if pressure is applied to the chamber's plunger, at least to a threshold pressure that is greater than that generated by typical inadvertent jostling of the plunger. As such, once the initial sample has entered the inner chamber there is no way, within reasonable and/or standard and/or typical use, for the initial (flush) sample to interact with or contaminate the second, desired sample.

In the preferred embodiment, this device is intended for single use. In other embodiments, the device could be used multiple times. However, in the event of multiple uses, the user would have to thoroughly wash, dry, and sterilize the device between uses. In addition, to return the dual syringe to the ready to use position as well as to accomplish the washing and sterilization process, the user would have to overcome the one-way valve located within the inner syringe's tip while maintaining the integrity of the valve for the next use.

### BRIEF DESCRIPTION OF THE DRAWINGS

FIG. 1 is a side view of a dual syringe in accordance with a first embodiment of the invention;

FIG. 2 is a perspective view of an inner barrel of the dual syringe of FIG. 1;

FIG. 2A is a perspective view of a rear of a rubber fitting with a one-way valve for the inner barrel of FIG. 2;

FIG. 2B is a perspective view of a front of the rubber fitting of FIG. 2A;

FIG. 3 is a side view of the inner barrel of FIG. 2;

FIG. 4 is a side view of an outer barrel of the dual syringe of FIG. 1;

FIG. 5 is a side view of the dual syringe of FIG. 1 before use to remove sampling fluid from a vessel or container;

FIG. 6 is a view similar to FIG. 5 with the dual syringe coupled to a sampling line before removal of fluid from the vessel or container;

FIG. 7 is a view similar to FIG. 6 where a plunger rod of the inner syringe has been operated by pulling and the inner barrel is filled to a desired degree with sampling fluid, but the outer syringe has not been filled yet;

FIG. 8 is a view similar to FIG. 7 where the inner barrel has been withdrawn to fill the outer barrel with sampling fluid to a desired amount;

FIG. 9 is a view similar to FIG. 8 where the dual syringe in its filled, post use state has been removed from the connection to the sampling port;

FIG. 10 is a view similar to FIG. 8 of a variation where the dual syringe is connected to an intravenous cannula; and

FIG. 11 is a view similar to FIG. 8 of a variation where the dual syringe is connected to a urinary catheter.

### DETAILED DESCRIPTION OF THE PREFERRED EMBODIMENTS

The following detailed description is of the best currently contemplated modes of carrying out exemplary embodiments of the invention. The description is not to be taken in a limited sense, but is made merely for the purpose of illustrating the general principles of the invention.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

In one or more embodiments, the present invention is a double barreled or dual syringe 1, i.e., a syringe device having an inner syringe and an outer syringe, where the inner syringe has its own plunger and the inner syringe has a barrel that functions as a plunger for the outer syringe. In use one will first pull on the plunger of the inner syringe to withdraw an initial portion of a specimen from a vessel through a one-way valve in a tip of the inner syringe, and into the inner syringe's barrel. Then, one will pull on the entire inner syringe to withdraw a sample portion of the specimen from the vessel into the outer syringe's barrel. Details are explained below.

Structure of the Dual Syringe

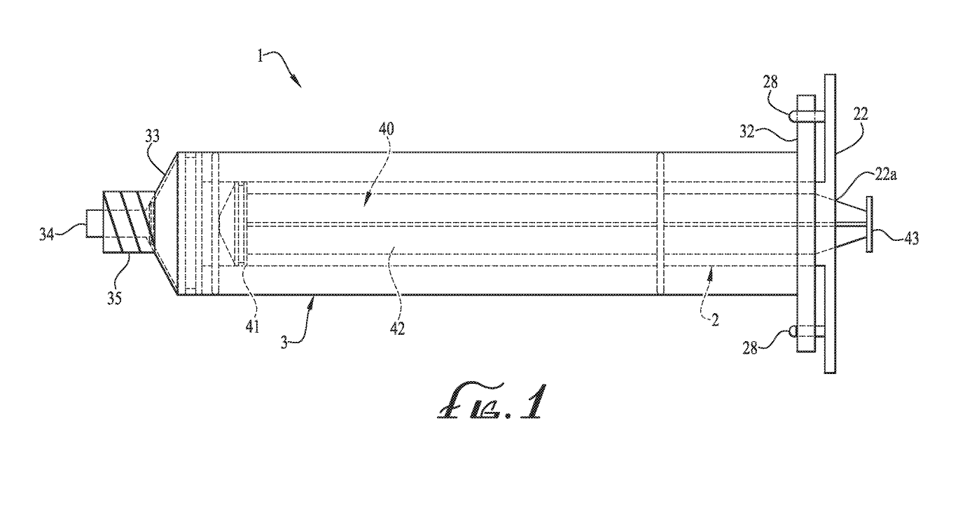

With reference to FIG. 1, a dual syringe 1 has an inner syringe 2 and an outer syringe 3.

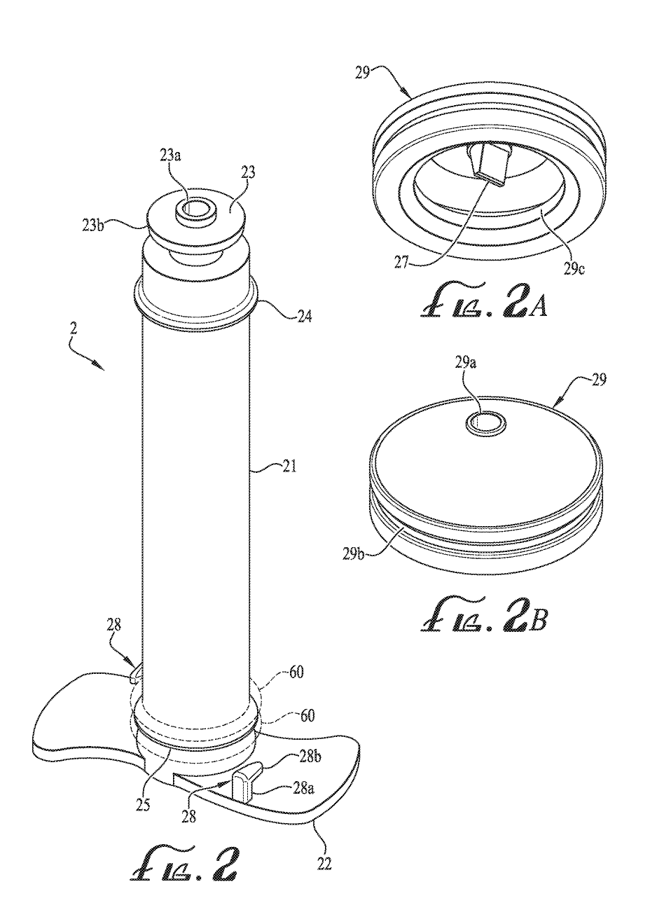

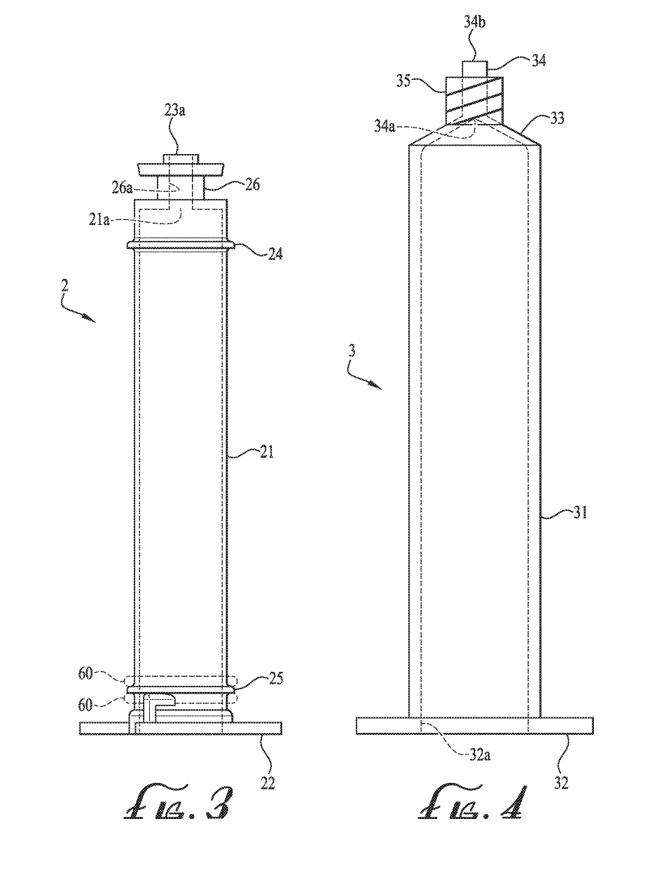

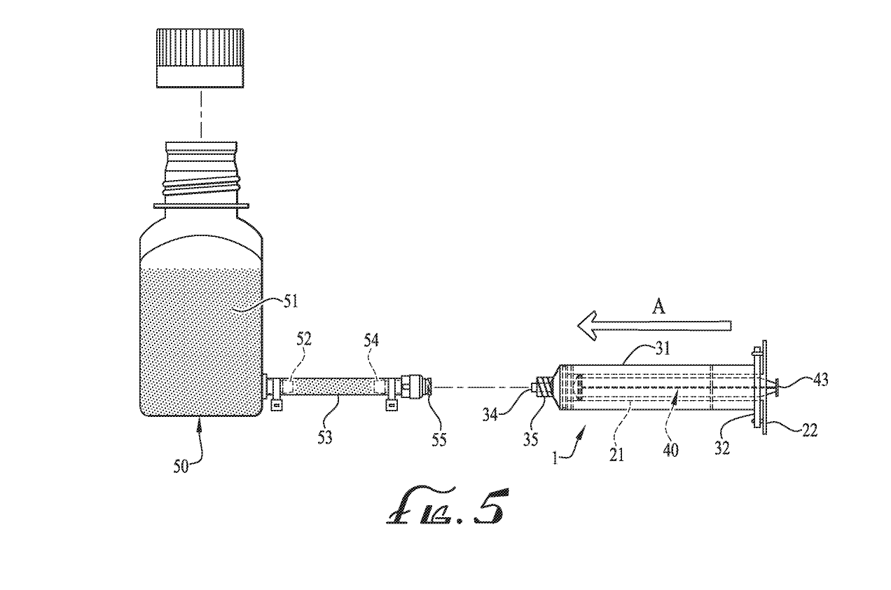

The inner syringe 2, details of which are shown in FIGS. 2 and 3, has an inner barrel 21. The inner barrel 21 has a flange portion 22 at its plunger or open end, and an extension or mounting member 23 at its tip end. Along inner barrel 21 are two ridges 24, 25 explained below.

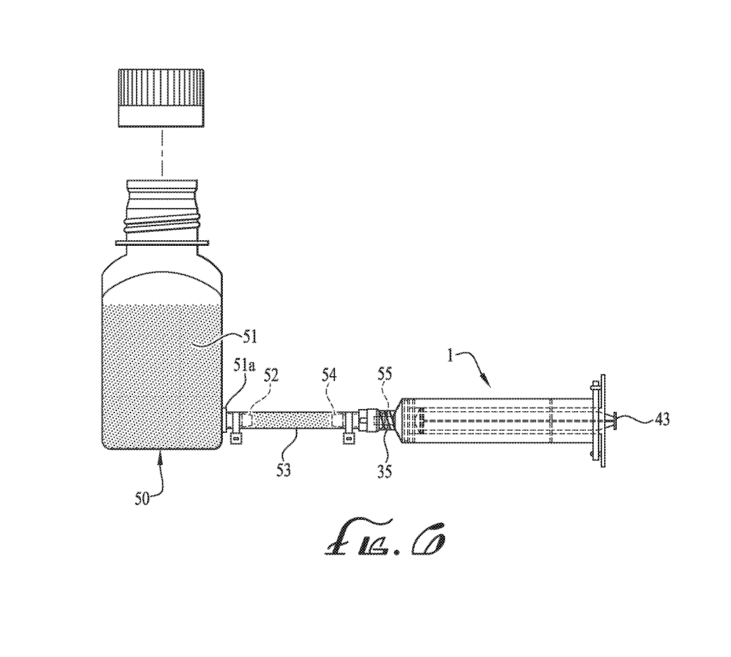

With reference to FIG. 4, the outer syringe 3 has an outer barrel 31. The outer barrel has a flange end 32, a tapered portion 33, and a tip preferably formed by an elongate nozzle 34. The tip or elongate nozzle 34 has an internally threaded locking ring 35 around it which may be fixed to the elongate nozzle 34 and/or the tapered portion 33. The locking ring 35 is preferably for forming a luer connection or a Luer-Lok® mechanism, i.e., a standardized lock connection to a sampling port of a vessel or container, a tube, or even a needle. However, a Luer-Lok® mechanism or locking ring is not required in lesser preferred embodiments. Further, in place of a Luer-Lok® mechanism, in preferred embodiments, there may be any fluid tight connection mechanism.

Where the Luer-Lok® connector is a male connector, it has an internally threaded outer portion for receiving an externally threaded outer portion of a female connector. The male connector also has an internal conduit that extends from the front of the male connector, and has a projecting portion at the rear for being friction fit into a passage or tube of a compatible radial size. In this case, the male connector's internal conduit may be considered as an extension of the elongate nozzle 34. The dual syringe may be made with the connector or without it. Other types of connectors, such as a slip tip fitting or a Luer slip tip may be used instead of the Luer-Lok® connector.

The mounting member 23 may be mounted on a nozzle end 26 of the inner syringe, both preferably formed unitary with (or attached to) the inner barrel 21. The nozzle end 26 preferably has a one-way valve member 27 (see FIG. 2A described below) disposed or formed therein, such as a duckbill (or any other suitable one-way) valve. The one-way valve member 27 is for enabling fluid to pass in one direction (from the tip towards the plunger end) through a one-way passage in the valve, as is well known in the art of one-way valves. Fluid will not flow in the opposite direction (injection direction) absent substantial force to overcome the valve. The configuration of nozzle end 26 and one-way valve 27 will depend on the method of its manufacture, as well as the type of valve employed.

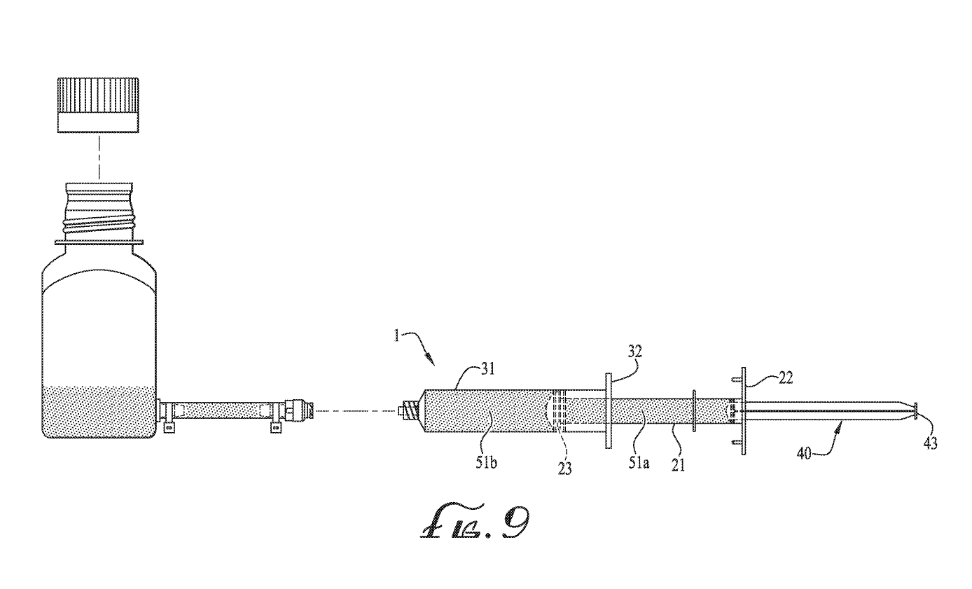

The mounting member 23 has an annular nose portion 23a. The mounting member 23 is shaped so as to support a rubber fitting 29 shown, e.g., in FIGS. 2A, 2B and 8. When the inner barrel 21 is fully inside the outer barrel 31 as shown, e.g., in FIG. 1, rubber fitting 29 forms a seal, preferably at its open cylindrical projection 29a, with an inner end 34a of the elongate nozzle 34 so that liquid, when being drawn in by the inner syringe 2, will not leak into the outer barrel 31, because both the inner barrel and the outer barrel can communicate with the elongate nozzle 34 at the inner end 34a.

Circumferential surface 29b of rubber fitting 29 forms a seal with the inside surface of the outer barrel 31. Accordingly, the inner barrel 21 itself acts as a plunger for the outer syringe 3. Open cylindrical projection 29a of the rubber fitting faces the tip of the dual syringe when the rubber fitting is fixed (such as friction or interference fit) on the mounting member 23. The open cylindrical projection provides a fluid pathway from the elongate nozzle 34 into the inner barrel via the one-way valve 27 and passageway 26a in nozzle end 26, through opening 21a into the inner barrel 21.

The rubber fitting 29 has an inner annular recess 29c which, when fixed on the mounting member 23, receives the circumferential edge 23b of the mounting member 23. In this position, the one-way valve 27 will protrude into an opening of the annular nose portion 23a of the mounting member, and be friction fit therein for a seal. The open cylindrical projection 29a will be friction fit over the annular nose portion 23a of the mounting member. Therefore, fluid can only pass through the open cylindrical projection 29a and annular nose portion 23a at nozzle end 26 and opening 21a to the interior of the inner barrel 21 by passing through the one-way valve 27.

A plunger rod 40 for the inner syringe is preferably a standard plunger, e.g., with a rubber seal 41 at its forward end to seal against opening 21a at a nozzle end of the inner barrel 21, an elongate body 42 and a handle 43 at its rear end. The rubber seal 41 also seals against the inner barrel 21, and therefore provides a friction fit within the inner barrel 21. The plunger rod's handle 43 may be pulled, as is well known, to form a chamber in the inner barrel and to create a vacuum (at least a partial vacuum) in such chamber, to draw fluid (liquid or gas) into the chamber.

As noted above, the inner syringe 2 forms a plunger for the outer syringe 3. The ridges 24, 25 act to stabilize the inner barrel 21 in the outer syringe, especially when the plunger rod 40 is being withdrawn from the inner barrel 21, and also when the inner barrel 21 is being withdrawn from the outer barrel 31. This stability is important, e.g., to help maintain the seal of the open cylindrical projection 29a and the seal of the circumferential surface 29b.

The flange portion 22 of the inner barrel 21 operates as a handle for the inner barrel 21, and together the flange portion 22 and inner barrel 21 form the plunger for the outer syringe 3. The seal from circumferential surface 29b of rubber fitting 29 with the inside of the outer barrel 31 operate to create a vacuum (at least a partial vacuum) as the inner barrel 21 is withdrawn from the outer barrel 31 by pulling on the flange portion 22. Fluid (liquid or gas) will be drawn into a chamber in the outer barrel 31 formed as the inner barrel 21 is withdrawn from the outer barrel 31.

The flange portion 22 of the inner syringe and the flange end 32 of the outer syringe preferably lock together, so that the inner syringe 2 (the inner barrel 21) will not come out of the outer barrel while one is pulling on the plunger rod 40. This locking mechanism helps maintain the seals provided by rubber fitting 29. While one could potentially make the device such that the force of friction (related to the coefficient of static friction) between the inner barrel 21 and the outer barrel 31 is sufficiently greater than the force of friction (related to the coefficient of static friction and dynamic friction) between the plunger rod's rubber seal 41 and the inner barrel 21 such that pulling the plunger rod 40 out of the inner barrel 21 will not cause the inner barrel 21 to move outwardly with respect to the outer barrel 31, this would be a lesser preferred version of the invention.

The flange portion 22 of the inner barrel 21 may have a fan blade type shape and/or recesses on each side, which may help ergonomics, by making it easier for a user to grab the flange portion 22 and use it as a handle, and also to twist it to disengage (or engage) the gripping portions 28b from the flange end 32 of the outer barrel 31.

A positive lock mechanism more securely avoids relative movement of the inner barrel 21 and outer barrel 31 during withdrawal of the plunger rod 40 or otherwise inadvertently. Such a lock mechanism may be an interference fit of the flange portion 22 of the inner syringe and the flange end 32 of the outer syringe. In accordance with one or more embodiments of the invention, a hook or hooks 28 may be formed on an inwardly facing surface (or otherwise formed to extend inwardly) from the flange portion 22. Hook(s) 28 have a projection portion 28a and a gripping portion 28b. The height of the projection portion 28a to the gripping portion 28b should be the same or essentially or substantially the same as the thickness of flange end 32. As can readily be understood from FIG. 1, where the locking mechanism is shown in an engaged position, gripping portions 28b will hold the flange portion 22 to the flange end 32. To create this engagement, one may make the hooks 28 sufficiently flexible so that pushing the flange portion 22 together with the flange end 32 will cause the hooks to splay outwardly until the flange portion and flange end are sufficiently close together that the gripping portions clear the flange end 32 and resiliency of the hooks, particularly the projection portions 28a, causing the projection portions to return to their resting position. In that position, the gripping portions 28b will grip the flange end 32.

As an alternative to forcing the flange portion 22 and flange end 32 together until the hooks engage, one may simply have the flange portion 22 and flange end 32 at different angular positions with respect to each other, so that a footprint of the gripping portions 28b in the direction of the flange end 32 will be clear of the flange end 32. Then, once the flange portion and flange end are sufficiently close together that the gripping portions will clear the flange end 32, relative rotation of the flange portion 22 and flange end 32 until the gripping portions grip the flange end 32 is performed to lock the flange portion and flange end together. A slight camming action may be helpful.

In order to release the lock mechanism, one may simply pull hard enough on flange portion 22 to overcome the grip of the hooks causing them to splay outwardly and the flange portion 22 will come free of the flange end 32. Alternatively, relative rotation of the flange portion 22 and flange end 32 until the gripping portions are clear of the flange end 32 may be performed.

Once the lock mechanism has been released, the inner barrel 21 may then be withdrawn from the outer barrel 31, breaking the seal of the open cylindrical portion 29a on the rubber fitting 29 with the outer barrel, enabling the outer barrel to communicate with its elongate nozzle 34 at opening 34a.

In another embodiment, the flange end 32 may have the hook(s) 28. In other embodiments, the lock mechanism may be formed by a different type of interference fit, such as by projection(s) from the flange portion 22 and/or from the flange end 32, which have an interference fit into an opening or openings or recess or recess in the other of the flange portion 22 and/or flange end 32. Additional locking mechanisms may be evident to one of ordinary skill in the art.

As noted above, the locking mechanism (or relative difference in friction embodiment) prevent inadvertent withdrawal of the inner barrel from the outer barrel, which would cause inadvertent entry of fluid into the outer barrel and thereby contaminate the outer barrel.

It should be noted that to enable the plunger rod 40 to move outward with respect to the inner barrel 21, flange portion 22 has an opening 22a of sufficient diameter that it is greater than a diameter of plunger rod's body 42. To prevent the plunger rod from coming all the way out of the inner barrel 21, the diameter of opening 22a is sufficiently small so as to block a widened diameter portion of the plunger rod, typically at or proximate rubber seal 41.

Similarly, to enable inner barrel 21 to move outward with respect to the outer barrel 31, flange end 32 has an opening 32a (FIG. 4) of sufficient diameter that it is greater than a diameter of the inner barrel 21. To prevent the inner barrel 21 from coming all the way out of the outer barrel 31, the diameter of opening 32a is sufficiently small so as to block a widened diameter portion of the inner barrel 21, e.g., at the external ridge 24.

Note that the inner and outer barrels may have graduation markings, which are optional.

It should also be noted that an O-ring 60 or O-rings 60 or the like may be provided around the inner barrel, e.g., proximate the plunger end of the inner barrel. The O-ring(s) 60 act as a barrier member that help seal the outer barrel from contaminants prior to use. In addition to and/or in lieu of the O-ring(s), other barrier mechanisms to protect the outer barrel from penetration of contaminants such as a sleeve, e.g., a flexible sleeve that attaches to to the outer barrel's flange end 32 (or proximate thereto) and also to the inner barrel's flange portion 22 (or proximate thereto). The O-ring(s) and/or any other barrier mechanism to seal the outer barrel from contaminants at the flange end are optional.

Construction

The dual syringe may be formed primarily of plastic. Typically, the rubber seal would be rubber, and if the one-way valve is a duckbill valve, then at least its (typically) one piece elastomeric component that forms the one-way seal would be rubber. As used herein, rubber may include any suitably resilient elastomeric material. The plastic may be any suitable plastic, such as polypropylene. Some components may be formed of other materials as needed, such as glass or stainless steel or other suitable materials evident to one of ordinary skill in the art.

For example, the inner barrel including all of its parts may be molded, e.g., of polypropylene, preferably in one piece although multiple pieces may be possible. The rubber fitting and the valve are then attached following molding. The plunger 40 may also be molded, e.g., of polypropylene, and the rubber seal may be mounted thereon following molding. Further, the outer barrel and all of its parts may be molded, e.g., of polypropylene, preferably in one piece although multiple pieces may be possible. As a modification, co-molding techniques may be used as possible, if desired.

Alternatively, the dual syringe could be made of fluorinated ethylene propylene (FEP), polytetrafluoroethylene (PTFE) and/or high density polyethylene (HDPE), as may be done in a Teflon® syringe (a syringe with certain parts such as its barrel and plunger coated with a polymerized tetrafluoroethylene (PTFE) or Teflon®). Teflon® has high chemical inertness. However, since the dual syringe is best embodied for one time use, a Teflon® construction is generally not required or needed.

Other suitable materials will be evident to those of ordinary skill in the art.

In a most preferred embodiment, the plunger rod 40 is a conventional plunger rod for a 10 ml syringe, and the outer barrel is a conventional 20 ml syringe barrel. Any locking system like a Luer Lok® on the outer barrel may be added (or included) or omitted as desired. The inner barrel 21 is made similar to a 10 ml syringe barrel, but with the ridges. The inner barrel is also made to fit a 20 ml syringe barrel (outer barrel 31) by providing an extended front end of the inner barrel's chamber, and/or providing the mounting member. The rubber fitting is disposed over the mounting member.

While the above size(s) are preferred to use some existing products, any other size could be used, depending on the preferences of the manufacturer, user, and/or the desired use.

Use of the Dual Syringe

In the completed assembly, the plunger rod 40 is shown here in FIG. 1 fully inserted inside the inner barrel 21, and the inner barrel 21 is fully inserted in the outer barrel 31. In this position, the rubber seal 41 of the plunger rod 40 prevents fluid flow into the inner syringe by sealing opening 21a in the inner barrel 21. Similarly, the rubber fitting 29 prevents fluid flow into the outer syringe by sealing an opening at inner end 34a of tip 34 (the elongate nozzle) of the outer barrel 31 with open cylindrical projection 29a. As previously mentioned, the passageway 26a is sealed from the inner barrel 21 by the plunger rod's rubber seal 41.

Because it is important for the dual syringe to be aseptic when stored until use, the dual syringe may have a cap (not shown) on the elongate nozzle 34 to seal opening 34b. Such a cap preferably will fit to the locking ring in a complimentary locking manner, such as a Luer-Lok® manner. The dual syringe may also have the O-ring(s) 60 to help provide an aseptic environment. In addition or alternatively, the entire dual syringe may be packaged in sealed plastic as is typically done for aseptic, single-use biological equipment.

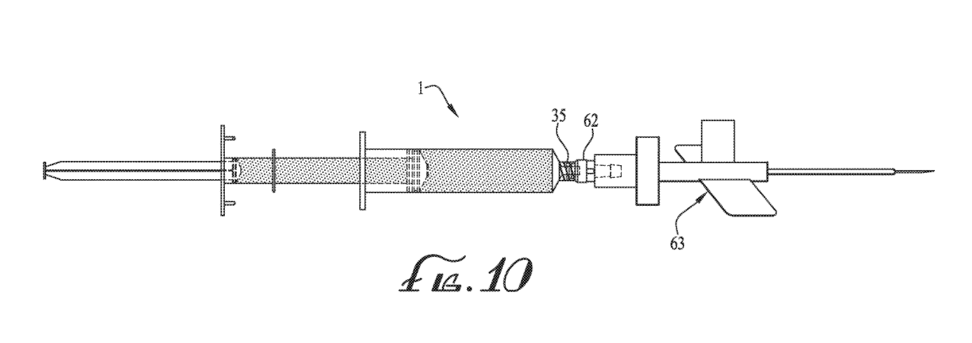

While FIG. 1 shows the assembled, storage or pre-use position of the dual syringe, FIGS. 5-9 show the dual syringe in use in accordance with a method of use. The package is opened, and the cap, if any, is removed. Then use takes place.

In use, typically a user (e.g., a laboratory technician or “lab tech”) who wants to take a sample from an aseptic culture or other biologic fluid normally in a bioreactor vessel or container 50, will spray or swab the reactor's sampling port and/or vessel port with disinfectant, e.g. alcohol, although it is an option not to use disinfectant as mentioned above.

Fluid 51, e.g., a biologic fluid from cell culture or body fluid, or other liquid or gas, may be extracted via a port 51a such as a vessel port. That port may have a first connector 52 attached to it. The first connector 52 may have a hose 53 attached to it, and then a second connector 54. The second connector 54 has a sampling port 55 fitted thereto. This series of connectors and the hose is for purposes of creating a port compatible with the locking mechanism of the elongate nozzle 34. The sampling port is preferably “Luer-Lok® compatible.” If the vessel port 51a is compatible with the locking mechanism of the elongate nozzle 34, then direct connection to the vessel port 51a would be possible. Also, note that a needle could be attached to the dual syringe and then a membrane penetrable by the needle could be used as the sampling port. The user may also spray or swab sampling port 55 with alcohol.

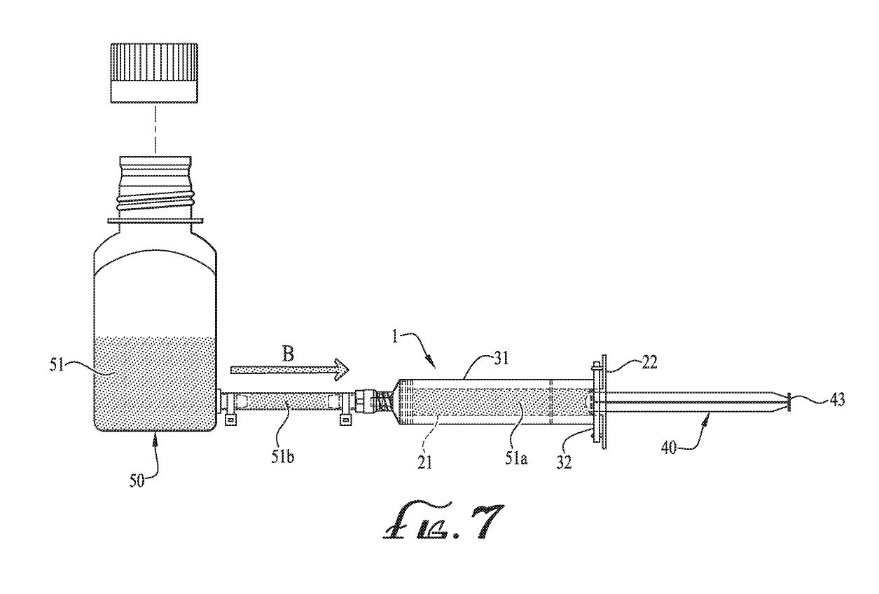

First, as shown in FIGS. 5 and 6, one moves the dual syringe in the direction of arrow A and connects the elongate nozzle 34 to a sampling port 55, which is preferably “Luer-Lok® compatible.” At this time, the dual syringe is in its storage or rest state of FIG. 1 and is connected to the sampling port 55.

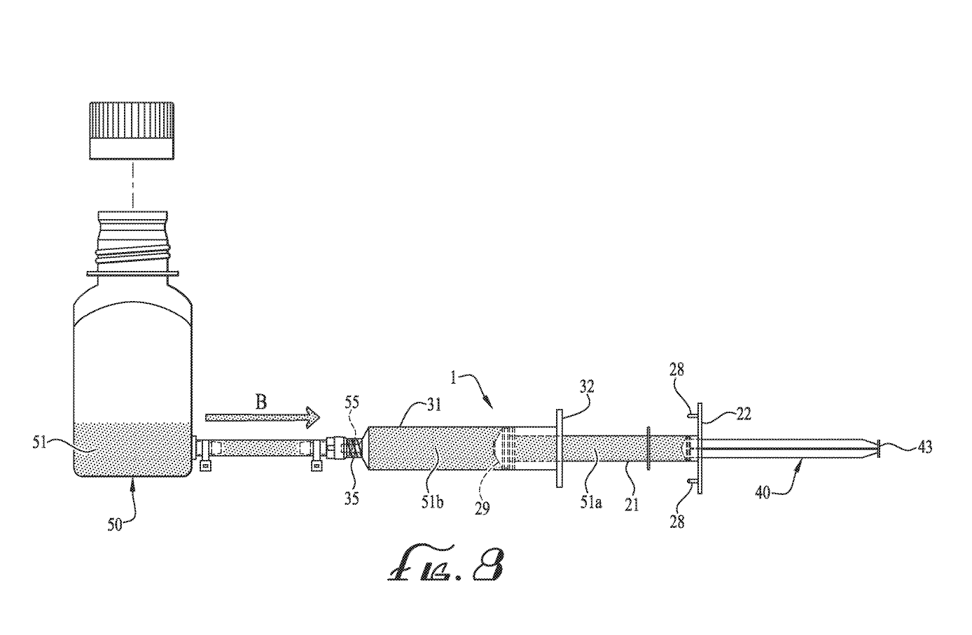

Second, as shown in FIG. 7, one pulls handle 43 of plunger rod 40 back as much as desired to withdraw some of fluid 51 from the vessel 50. The fluid is drawn out of the vessel 50, through the hose 53 (in the direction of arrow B) through the elongate nozzle 34, through the one-way valve 27 and into the inner barrel 21. This initially drawn fluid 51a stays in the inner barrel and cannot contaminate the outer barrel 31 due to the one-way valve 27.

Third, as shown in FIG. 8, one twists flange portion 22 or otherwise separates or overcomes the attachment of the gripping portions 28b of the flange portion 22 of the inner barrel 21 to the flange end 32 of the outer barrel. One pulls on the flange portion 22 to withdraw the inner barrel 21 from the outer barrel 31, which unseals the opening 34a of the elongate nozzle by removing the rubber fitting 29. This action of pulling the flange portion and thus extracting the inner barrel 21 causes the outer syringe to draw fluid (in the direction of arrow B) into the outer barrel 31, which fluid is now the desired sample fluid 51b.

Now, with the desired amount of sample 51b in the outer barrel, the dual syringe may be used to expel sample (by pushing forward (inward) on the flange portion 22 of the inner barrel 21 or on handle 43 of plunger rod 40) as needed for testing or other use, or a probe could be inserted through the elongate nozzle 34 to aspirate the sampled fluid.

As can be surmised from the drawings and above discussion, fluid can sometimes be left in the hose and/or other structure associated with the sample port. While draining that fluid and sterilizing the sampling port's structure may or may not be possible or practical, and/or replacing such structure may or may not be possible or practical, in any situation where fluid or residue of the fluid remains or may remain in the structure associated with the sampling port, it is or may be a further advantage of the dual syringe of preferred embodiment(s) that the sampling port and associated structure is flushed without having to disconnect and reconnect to the sampling port, thereby minimizing any chance of contamination.

Variations

Variations of the preferred embodiment(s), including but not limited to any embodiment disclosed herein, will be evident to those of ordinary skill in the art. For example, instead of a duckbill valve, other valve types may also be used, such as ball, umbrella, dome, cross-slit or other types or combinations thereof.

Instead of a male Luer-Lok® connector, a female connector or other type of connector may be used, or may be added later as needed for use.

Also, by way of example, the mounting member may be separately constructed from the inner syringe and then integrally affixed thereto. The valve 27 may be separately constructed from the rubber fitting 29. The rubber fitting 29 and/or the rubber seal 41 may be made of other materials, and/or may be formed unitarily with and/or integrally attached to the inner barrel and plunger, respectively. In some embodiments, the rubber fitting 29 and/or the rubber seal 41 may be made of the same materials as the inner barrel and plunger, respectively. In other embodiments, the rubber fitting and/or rubber seal may be formed in two or more pieces. E.g., the rubber fitting may be small and only seal the nozzle when in the seated position, and there may be another member for sealing the interior of the outer barrel with respect to the inner barrel, e.g., another O-ring such as an O-ring proximate the ridge 24 and/or two O-rings sandwiching the ridge 24. Alternatively, and/or in addition thereto, there may be a seal member with a passageway that communicates the nozzle with the inner barrel, which seal member is fixed to the outer barrel around the inner end 34a of the elongate nozzle 34 so as to form a seal against fluid entering the outer barrel when the inner barrel is seated (fully inserted in the outer barrel). The O-ring(s) proximate ridge 24 may be used in such an embodiment, or another way to seal the interior of the outer barrel to the inner barrel.

In some embodiments, optional lubrication of moving parts may be helpful and/or coating surfaces of the inside of the outer barrel, the inside and outside of the inner barrel, and/or the plunger may be desired to lubricate and/or to provide an inert coating with respect to the materials to be sampled.

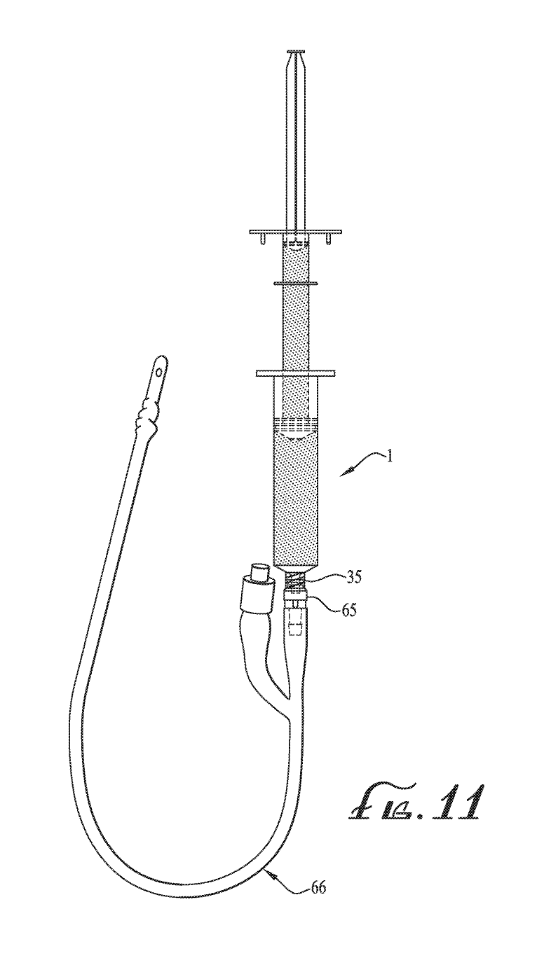

FIG. 10 shows use of the dual syringe by connecting its (e.g., male) Luer-Lok® connector 35 of elongate nozzle 34 to a (e.g., female) Luer-Lok® connector 62 of an intravenous cannula 63. Fluid may be sampled in the same manner as explained with respect to FIGS. 5-9.

FIG. 11 shows use of the dual syringe by connecting its (e.g., male) Luer-Lok® connector 35 of elongate nozzle 34 to a (e.g., female) Luer-Lok® connector 65 of a collection port of a urinary catheter 66 by using various fitting adaptors as needed or with the help of a modification, examples of which may include, but are not limited to, a slip tip, a tapered extension of the outer barrel, or an adapter device.

Additional Use Information

In one embodiment of the present invention its primary use is for the sampling of cell cultures from bioreactors with the aim of reducing the likelihood of contamination. In order to do so, the user will first spray the sampling port with alcohol to disinfect it. Next, the user will attach a new, sterile dual syringe. The user will then pull the plunger of the inner syringe back until the sampling path or input line has been flushed sufficiently. The user then overcomes the locking mechanism that prevents the outer syringe from moving during use of the plunger of the inner syringe and pulls the inner syringe, filling the larger chamber with the desired sample fluid for analyses. Once completed, the user detaches the dual syringe from the sampling port and continues with the process of analyzing the sample. In traditional sampling, these two processes must be accomplished separately via two different syringes, causing the user to flush with a first syringe, detach that first syringe, attach a second syringe, and then take the actual sample in the second syringe. Application of disinfectant to the sampling port is generally not desirable immediately prior to attachment of the second syringe because residual disinfectant may contaminate the desired sample fluid. This process of detachment of first syringe, non-application of disinfectant, followed by attachment of second syringe presents a serious risk of inadvertent introduction of microbial contaminants into the bioreactor. The dual syringe in accordance with embodiments of the invention eliminates that risk by providing a method of sampling following engagement with only a disinfectant-laden sampling port. Both flushing of the sampling path and collection of desired sampling are achieved following a single connection. Any applied disinfectant which may have been drawn into the device is washed into the inner barrel by the flushed fluid and retained therein. The desired sample (in the outer barrel) is, therefore, free of disinfectant and representative of the fluid in the source vessel.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A dual syringe, the dual syringe comprising:
an inner barrel having a longitudinal axis;
a plunger disposed in the inner barrel and movable with respect to the inner barrel along the longitudinal axis; and
an outer barrel having the inner barrel disposed therein and the inner barrel being movable with respect to the outer barrel along the longitudinal axis and having a forward end with a nozzle communicating an exterior of the outer barrel with an interior of the outer barrel,
wherein the inner barrel has a nose portion with a fluid passage defined therein in communication with the nozzle when the inner barrel is fully inserted in the outer barrel, and wherein the inner barrel has a one-way valve disposed in the fluid passage allowing fluid to pass from outside the inner barrel to an inside of the inner barrel.

2. The dual syringe of claim 1, wherein the plunger is movable between a fully inserted position where a tip of the plunger blocks the fluid passage from communication with the inside of the inner barrel, and wherein when the plunger is at least partly withdrawn from the fully inserted position, an inside chamber is formed inside the inner barrel for allowing fluid to pass from outside the inner barrel to an inside of the inner barrel.

3. The dual syringe of claim 1, wherein the inner barrel is movable between a fully inserted position in the outer barrel where a forward portion of the inner barrel blocks fluid communication of the nozzle with the interior of the outer barrel and an at least partly withdrawn position where the nozzle is open to communicate with the interior of the outer barrel for allowing fluid to pass from outside the outer barrel to the interior of the outer barrel.

4. The dual syringe of claim 1, further comprising means for retaining the inner barrel in the fully inserted position when the plunger is being withdrawn from the inner barrel.

5. The dual syringe of claim 4, wherein the means for retaining comprises an interference fit of the inner barrel and the outer barrel.

6. The dual syringe of claim 4, wherein, at an end of the outer barrel opposite the forward end, the outer barrel has a flange end and the inner barrel has a flange portion, wherein the means for retaining comprises an interference fit between the flange end of the outer barrel and the flange portion of the inner barrel.

7. The dual syringe of claim 5, wherein the flange end and the flange portion each extend transverse to the longitudinal axis and the interference fit is provided by the flange portion having gripping members therein that extend to and grip the flange end.

8. The dual syringe of claim 1, wherein, at an end of the outer barrel opposite the forward end, the outer barrel has a flange end and the inner barrel has a flange portion, and the flange end and the flange portion each extend transverse to the longitudinal axis and have an interference fit provided by the flange portion having gripping members therein that extend to and grip the flange end.

9. The dual syringe of claim 4, wherein the plunger has an elastomeric seal at a forward end thereof for sealing the fluid passage from communication with the inside of the inner barrel when the plunger is fully inserted in the inner barrel, and the rubber seal having a circumferential surface which is friction fit against an inner radial surface of the inner barrel, and the inner barrel has an elastomeric fitting at its forward end for forming a seal around the nozzle so as to seal the nozzle from communication with the interior of the outer barrel, and the elastomeric fitting has a circumferential surface which is friction fit against an inner surface of the outer barrel, wherein a force of static friction necessary for relative motion of the inner barrel and the outer barrel is greater than a force of static friction necessary for relative motion of the plunger and the inner barrel.

10. The dual syringe of claim 1, wherein the inner barrel has a mounting member extending toward the fluid passage of the outer barrel and extending from a forward end of the inner barrel, and has an elastomeric fitting mounted around the mounting member.

11. The dual syringe of claim 10, wherein the elastomeric fitting and the one-way valve are formed in one piece.

12. The dual syringe of claim 1, wherein the one-way valve is a duckbill valve.

13. The dual syringe of claim 1, wherein the inner barrel has externally extending ridges for stabilizing the inner barrel within the outer barrel.

14. The dual syringe of claim 1, further comprising a barrier member which is disposed between the outer barrel and the inner barrel to keep contaminants from entering a space between the inner barrel and the outer barrel.

15. A dual syringe, the dual syringe comprising:
an inner barrel having a longitudinal axis;
a plunger disposed in the inner barrel and movable with respect to the inner barrel along the longitudinal axis; and
an outer barrel having the inner barrel disposed therein and movable with respect to the outer barrel along the longitudinal axis and having a forward end with a nozzle communicating an exterior of the outer barrel with an interior of the outer barrel,
wherein the inner barrel has a nose portion with a fluid passage defined therein in communication with the nozzle when the inner barrel is fully inserted in the outer barrel,
wherein the plunger is movable between a fully inserted position where a tip of the plunger blocks the fluid passage from communication with the inside of the inner barrel, and wherein when the plunger is at least partly withdrawn from the fully inserted position an inside chamber is formed inside the inner barrel, the fluid passage for allowing fluid to pass from outside the inner barrel to an inside of the inner barrel, and
wherein the inner barrel is movable between a fully inserted position in the outer barrel where a forward portion of the inner barrel blocks fluid communication of the nozzle with the interior of the outer barrel and an at least partly withdrawn position where the nozzle is open to communicate with the interior of the outer barrel for allowing fluid to pass from outside the outer barrel to the interior of the outer barrel.

16. The dual syringe of claim 15, wherein the plunger has an elastomeric seal at a forward end thereof for sealing the fluid passage from communication with the inside of the inner barrel when the plunger is fully inserted in the inner barrel, and the rubber seal having a circumferential surface which is friction fit against an inner radial surface of the inner barrel, and the inner barrel has an elastomeric fitting at its forward end for forming a seal around the nozzle so as to seal the nozzle from communication with the interior of the outer barrel, and the elastomeric fitting has a circumferential surface which is friction fit against an inner surface of the outer barrel.

17. The dual syringe of claim 16, wherein the inner barrel has a mounting member extending toward the fluid passage of the outer barrel and extending from a forward end of the inner barrel, and has an elastomeric fitting mounted around the mounting member, and the plunger has an elastomer seal disposed at the forward end thereof.

18. The dual syringe of claim 15, wherein the outer barrel is for a standard 20 ml syringe and the plunger is for a standard 10 ml syringe.

19. The dual syringe of claim 15, further comprising a barrier member which is disposed between the outer barrel and the inner barrel to keep contaminants from entering a space between the inner barrel and the outer barrel.

20. A dual syringe, the dual syringe comprising:
an inner barrel having a longitudinal axis;
a plunger disposed in the inner barrel and movable with respect to the inner barrel along the longitudinal axis; and
an outer barrel having the inner barrel disposed therein and the inner barrel being movable with respect to the outer barrel along the longitudinal axis and having a forward end with a nozzle communicating an exterior of the outer barrel with an interior of the outer barrel,
wherein the inner barrel has a nose portion with a fluid passage defined therein in communication with the nozzle when the inner barrel is fully inserted in the outer barrel and the inner barrel has means for allowing fluid flow from the nozzle into the inner barrel in a first direction via the passageway and for preventing fluid flow from the inner barrel through the passageway in a second direction opposite to the first direction, and wherein the interior of the outer barrel is in communication with the nozzle when the inner barrel is at least partly withdrawn from the outer barrel, and wherein a tip of the outer barrel has a fitting disposed thereon in fluid communication with the nozzle and for fluid tight mating with another fitting.

21. A method of use of a dual syringe for obtaining a desired sample fluid, the dual syringe comprising:
an inner barrel having a longitudinal axis;
a plunger disposed in the inner barrel and movable with respect to the inner barrel along the longitudinal axis; and
an outer barrel having the inner barrel disposed therein and movable with respect to the outer barrel along the longitudinal axis and having a forward end with a nozzle communicating an exterior of the outer barrel with an interior of the outer barrel,
wherein the inner barrel has a nose portion with a fluid passage defined therein in communication with the nozzle when the inner barrel is fully inserted in the outer barrel, and
wherein the inner barrel has a one-way valve disposed in the fluid passage allowing fluid to pass from outside the inner barrel to an inside of the inner barrel, and
wherein the method comprises the steps of:
a. connecting the forward end at the nozzle with a sampling port for a fluid to be sampled to make a fluid tight connection between the nozzle and the sampling port;
b. at least partially withdrawing the plunger from the inner barrel until a first portion of the fluid to be sampled is drawn into and disposed in the inside of the inner barrel; and
c. at least partially withdrawing the inner barrel from the outer barrel until a second portion of the fluid to be sampled is drawn into and disposed in the interior of the outer barrel.

22. The method of claim 21, wherein the steps b and c are performed while maintaining the fluid tight connection with the sample port as formed in step a.

23. The method of claim 21, wherein the second portion of the fluid is expelled as needed for use as the desired sample fluid by pressing the inner barrel or plunger towards the fully inserted position while the first portion of the fluid is maintained in the inside of the inner barrel by the one-way valve.

24. The method of claim 21, wherein the fluid comprises one of a biologic fluid which is a cell culture or body fluid.
